(19) United States
(12) Patent Application Publication
(10) Pub. No.: US 2023/0135135 A1
(43) Pub. Date: May 4, 2023

(54) PREDICTING OUTCOMES OF INTEREST

(71) Applicant: AM MobileApps, LLC, Seattle, WA (US)

(72) Inventors: John Robert Hudson Misko, Seattle, WA (US); Alexander Francis Woodhouse, Seattle, WA (US)

(21) Appl. No.: 17/807,064

(22) Filed: Jun. 15, 2022

Related U.S. Application Data
(60) Provisional application No. 63/263,327, filed on Oct. 29, 2021.

(51) Int. Cl. G06N 20/20

(52) U.S. Cl. CPC G06N 20/20; G06Q 30/0201

(57) ABSTRACT

Examples are disclosed that relate to determining probabilities for possible candidates taking an action of interest. One example provides a computing system comprising a logic subsystem and a storage subsystem comprising instructions executable to obtain a list of possible candidates and enrichment data for each possible candidate. The instructions are further executable to, for each possible candidate on the list of possible candidates, determine a confidence regarding an identity of the possible candidate based at least on the enrichment data, when the confidence regarding the identity of the possible candidate satisfies a threshold condition, determine, by inputting information regarding the identity and the enrichment data into a trained machine learning model, a probability that the possible candidate will take an action of interest, and when the probability meets a threshold probability, add the possible candidate to a list of candidates, and output the list of candidates.

### CROSS REFERENCE TO RELATED APPLICATIONS

The present application is based upon and claims priority under 35 U.S.C. 119(e) to U.S. Provisional Patent Application No. 63/263,327, entitled PREDICTING OUTCOMES OF INTEREST, filed Oct. 29, 2021, the entirety of which is hereby incorporated herein by reference for all purposes.

### BACKGROUND

Some entities expend much time and resources trying to identify candidates that may wish to engage with the person or organization in some manner, such as via a transaction or membership. However, the population of possible candidates can be extremely large. As such, significant resources may be expended toward possible candidates that have a low likelihood of eventually engaging with the person or organization.

### BRIEF DESCRIPTION OF THE DRAWINGS

FIGS. 1A-1D depict example scenarios in which a computing device is used to obtain lists of possible candidates for which probabilities taking an action of interest are computed.

FIG. 2 schematically depicts an example use environment for operating a system for generating lists of candidates.

FIG. 3 schematically depicts an example system configured to generate a list of possible candidates each accompanied by a probability that the corresponding possible candidate will take an action of interest.

FIG. 4 schematically depicts an example system configured to generate a list of possible candidates each accompanied by a probability that the corresponding possible candidate will take an action of interest when contacted by a possible contact.

FIG. 5 schematically depicts an example data set from which at least a portion of input data may be derived that is input to a machine learning model to obtain a probability of a possible contact taking an action of interest.

FIG. 6 schematically depicts a flow diagram illustrating an example method for training a machine learning model.

FIG. 7 depicts a flow diagram illustrating an example method for outputting a list of possible candidates each with a corresponding probability that the possible candidate will take an action of interest.

FIG. 8 depicts a flow diagram illustrating an example method for outputting a list of possible candidates each with a corresponding probability that the possible candidate will take an action of interest when contacted by a possible contact.

FIG. 9 schematically depicts an example computing system.

### DETAILED DESCRIPTION

The terms “entity” and “candidate” and the like as used herein each can refer to a person or an organization. The terms “possible candidate” as used herein refers to an entity within a population of entities of which some members are more likely to engage with another entity and some members are less likely to engage with the other entity. The term “candidate” as used herein refers to an entity determined to have at least a threshold probability of engaging with another entity. The term “contact” refers to a person that may establish some form of interaction with another person. The term “probability” as used herein refers to a probability that a possible candidate will take an action of interest either where the probability is not conditional upon the possible candidate being contacted by a possible contact, or where the probability is conditional upon the possible candidate being contacted by a possible contact.

As mentioned above, entities can exert significant resources in trying to identify possible candidates considered likely to engage with the entity. One method is to identify possible candidates within a target population (e.g. geographic region, demographic, etc.), and make direct contact with each possible candidate. However, some possible candidates are more likely than others to engage with the entity. Given the potentially large size of many populations of possible candidates, making direct contact with all possible candidates may not be practical, or even possible for many entities, and may involve devoting time and resources to a large number of possible candidates with a low likelihood of engagement. Thus, making direct contact without first paring down a list of potential entities may consume resources unproductively.

As such, entities often turn to various forms of technology to help identify candidates from a large list of possible candidates. Identifying candidates relatively early, as opposed to after expending resources on candidates not likely to engage with the entity, may help to increase efficiencies and decrease costs. To identify possible candidates likely to engage, an organization may leverage external data services that provide demographic data for possible candidates. However, manually selecting candidates using demographic data can be a slow and tedious process, and may not successfully identify candidates likely to engage with the entity.

Accordingly, examples are disclosed that relate to using machine learning techniques to identify, from within a population of possible candidates, candidates likely to take an action of interest. Machine learning algorithms have gained popularity for their ability to model complex, nonlinear relationships and their suitability to large data sets. As described in more detail below, machine learning algorithms may be configured to predict outcomes of interest using appropriate labeled training data regarding previous possible candidates and information regarding whether an outcome of interest was achieved for each previous possible candidate.

In some examples, training data for some use contexts may not initially be available. Thus, in such examples, a machine learning model trained at least partially based on training data regarding previous possible candidates for another entity may be used as an initial model, and the model may be updated using training data from the intended use context once such training data is available. Further, in some examples, a probability that a possible candidate will take an action of interest is determined based upon data regarding the entity that may contact the possible candidate, as well as upon data regarding the possible candidate. In yet further examples, a probability that a possible candidate will take an action of interest is determined based on how the possible candidate may be contacted, such as through a recommendation (e.g. of a product, a media item, etc.).

The disclosed examples may be used to predict a probability of any suitable action of interest being taken. Examples of actions of interest include, but are not limited to, becoming a member of an organization, purchasing a product, subscribing to a service, donating to a charity, and applying to an educational institution.

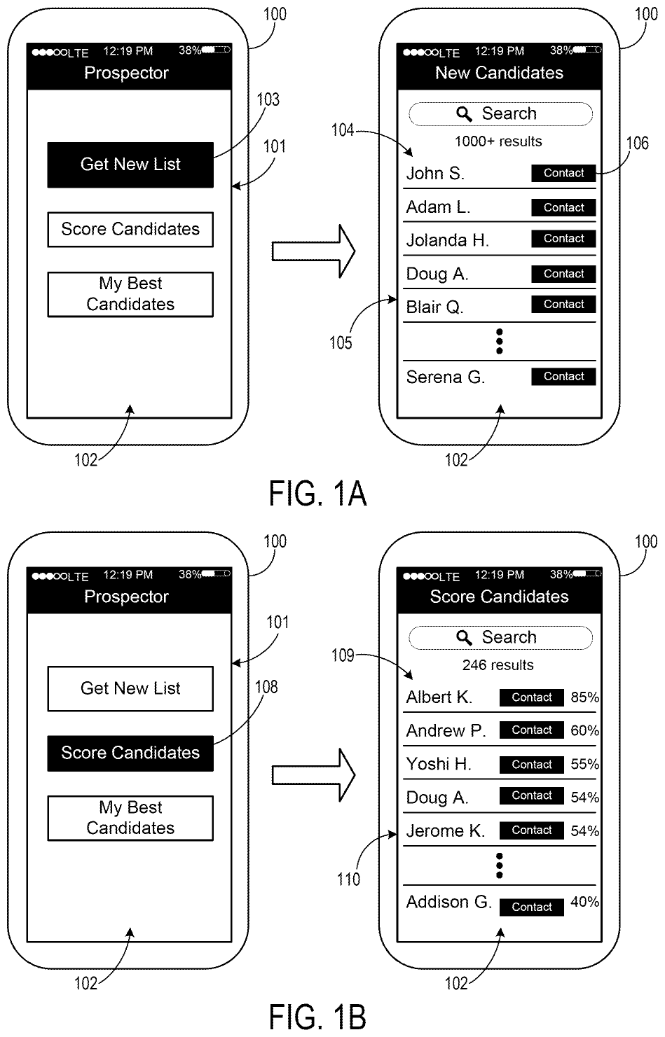

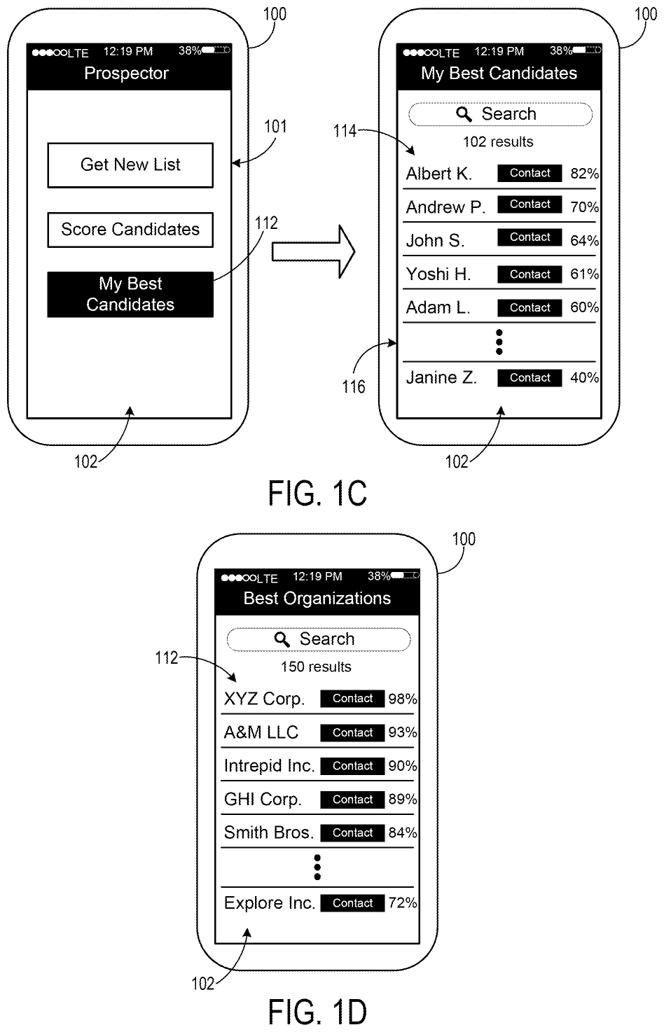

FIGS. 1A-1D depict an example scenario in which machine learning techniques may be used to produce a list of candidates from a larger list of possible candidates based upon a predicted probability that the candidates may take an action of interest. While computing device 100 is depicted as a mobile computing device, any other suitable computing device may be used in a process to generate a list of candidates from a larger list of possible candidates.

Referring first to FIG. 1A, a computing device 100 is depicted as running an application 102 for generating lists of candidates. In some examples, application 102 may take the form of a client application that runs locally on computing device 100 and interfaces with a remote service. In other examples, application 102 may take the form of a cloud-based application accessible by a web browser executed on computing device 100. In further examples, application 102 may take any other suitable form.

In FIG. 1A, a user of application 102 selects a control 103 titled “Get New List” to obtain a list of possible candidates. In response, the computing device 100 contacts a remote service (not shown in FIG. 1A) to request a list of possible candidates. The request to the remote service may include filter information to constrain the size of a set of results returned. Examples of such filter information include geographic location, age, and/or demographic information.

FIG. 1A, at user interface 105, shows an example of a list 104 of possible candidates returned based upon this request. List 104 includes possible candidates, some of whom may be less likely to engage with the entity, and some of whom may be more likely to engage with the entity, but for whom a probability of engaging has not yet been determined. List 104 also may include a control 106 selectable to contact the possible candidate, such as by text message, email or phone.

In some instances, list 104 may be quite long, and may include thousands, tens of thousands, or even more, names, depending upon the scope of the query performed to obtain list 104. Such a large number of results is indicated in FIG. 1A at user interface 105 as “1000+ results.” Thus, as mentioned above, a trained machine learning function may be used to obtain a smaller list of candidates from the list of possible candidates, where the list of candidates includes candidates determined to have at least a threshold probability of engaging with the entity that obtained the list. Thus, the probability determination may be used to cull possible candidates with a lower probability of taking the action of interest.

FIG. 1B illustrates the use of application 102 to obtain a list of candidates from a list of possible candidates. At user interface 101, the operator of computing device 100 selects a control labeled 108 “score candidates.” This control is configured to obtain probabilities that possible candidates on list 104 will take the action of interest. As described in more detail below, to determine this probability, enrichment data for each possible candidate on list 104 is obtained and used as an input into a trained machine learning function. The enrichment data can be obtained at the time list 104 is obtained, or may be obtained for possible candidates on list 104 upon selection of control 108. The enrichment data can be stored locally at computing device 100, and/or stored remotely. Further, trained the machine learning function can be run locally on computing device 100, and/or run on a remote service, in various examples. Example machine learning models are described in more detail below.

In some instances, some names on list 104 may be discarded during the probability determination, for example based upon determining that the identity of the possible candidate is not correct, or based upon having insufficient enrichment data. After obtaining the probabilities for possible candidates on list 104, the probabilities can be thresholded, and possible candidates with a probably meeting a threshold condition (e.g. a lower probability limit) can be added to a list of candidates. List 109 includes possible candidates from list 104 that have probabilities of taking an action of interest that meet a selected threshold probability. As shown at user interface 110, the scoring and thresholding process culled the 1000+ names in list 104 to two hundred forty-six names, thus significantly reducing the number of candidates to possibly contact. In this example, it can be seen that relatively few individuals are determined to have high probabilities of taking an action of interest, but a larger number of individuals have probabilities closer to the threshold value. The last name on list 109 (Addison G.) shows that a 40% probability was chosen as a threshold. In other examples, the list of candidates may have any other suitable probability distribution. In some examples, the threshold may be user selectable. In such examples, a user of application may select a higher threshold to obtain a shorter, more focused list, and may select a lower threshold to capture a wider variety of candidates.

In some instances, enrichment data also may be available for a person that requested list 104, or for multiple members of an organization for which list 104 was requested. In such instances, a machine learning function may be trained using enrichment data for both persons within an organization as well as for possible candidates (including specific persons at possible candidate organizations). Such a machine learning function may predict different probabilities for a possible candidate to take an action of interest for different “contacts” (different people within an organizational entity). The term “possible contact” refers to a person at an organizational entity who is considered along with a possible candidate to compute such a probability based upon the possible contact contacting the possible candidate.

FIG. 1C illustrates selection of a control labeled “My Best Candidates” 112 on user interface 101. This control causes enrichment data for the operator of application 102 to be input into a trained machine learning function along with the identities and enrichment data for possible candidates on list 104. As shown, list 114 has overlap with list 109, but also has differences. Further, some probabilities changed when the enrichment data for the user of application 102 was considered (on the basis of the user being a possible contact). For example, Andrew P. was determined to have a 60% likelihood without consideration of the enrichment data of the user of application 102, whereas Andrew P. was determined to have a 70% likelihood of taking the action of interest when the enrichment data of the user of application 102 was considered. Using such a trained machine learning function, an organization can determine lists of possible candidates for multiple different possible contacts within the organization and then provide personalized lists of contacts to different possible contacts within the organization, and thereby may increase an efficiency of achieving outcomes of interest.

In the examples depicted in FIGS. 1A-1C, the possible candidates identified by application 102 comprise individuals. In other examples, alternatively to or in addition to identifying individuals, application 102 can provide lists of organizations or other collections of individuals. FIG. 1D illustrates an example in which organizations (e.g., businesses, non-profits, etc.) are identified in a list 112 of possible candidates, along with probabilities that each organization may take an action of interest. In this example, such probabilities may or may not be conditional upon the possible contact who may potentially contact the organization.

While the examples depicted in FIGS. 1A-1D illustrate how possible candidate lists may be obtained via a graphical user interface (GUI), possible candidate lists may be obtained using other types of interfaces. As one example, a speech recognition interface may be used to obtain lists of possible candidates. Other interfaces that support natural user input (NUI) may also be used to obtain lists of possible candidates.

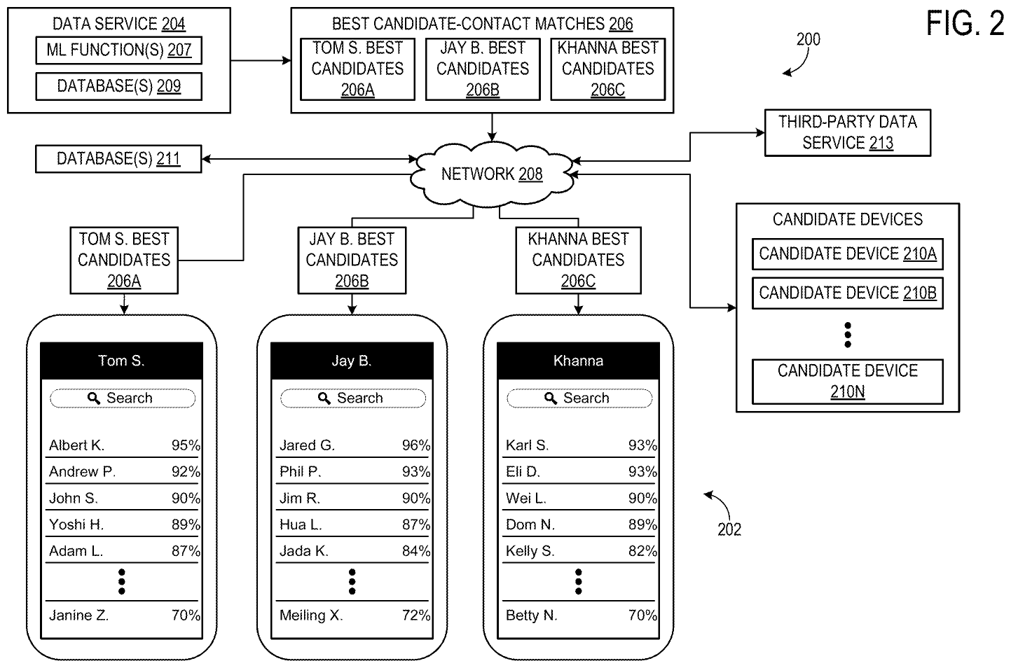

FIG. 2 schematically depicts an example use environment 200 for producing lists of candidates as described above. System 200 comprises a plurality of computing devices associated with entities to which lists of candidates are provided. Each computing device 202 may receive possible candidate lists via execution of application 102, for example.

Computing devices 202 are in communication with a remote data service 204 via a computer network 208. Remote data service comprises one or more trained machine learning function(s) 207 configured to generate, for each computing device 202, a list 206 of candidates personalized to the user of the computing device. Each list 206 of candidates includes possible candidates that were found to meet a threshold probability that the possible candidate will take an action of interest conditional upon being contacted by a possible contact (e.g. a user of the corresponding computing device 202). Through the personalization of candidate lists 206 in this manner, system 200 may identify candidates likelier to take actions of interest to an ecosystem of possible contacts. System 200 also may be used to produce lists not personalized for a possible contact, but rather based upon the enrichment data for each candidate.

Data service 204 may access one or more local database(s) 209 and/or one or more remote database(s) 211 to obtain identifications of possible candidates for producing a list of candidates (e.g. list 104). The one or more local database(s) 209 and/or one or more remote database(s) 211 also may be accessed to obtain enrichment data for the possible candidates. Data service 204 further may obtain enrichment data for possible contacts (operators of devices 202 in this example) from the one or more local databases 209 and/or the one or more remote databases 211. In some examples, data service 204 may utilize a third-party data service 213 in communication with network 208 to obtain data used to formulate lists of candidates.

FIG. 2 also illustrates computing devices 210 each associated with a possible candidate as connected to network 208. A user of a computing device 202—acting as a possible contact—may contact a possible candidate (through an associated computing device 210) identified in a list 206 via network 208.

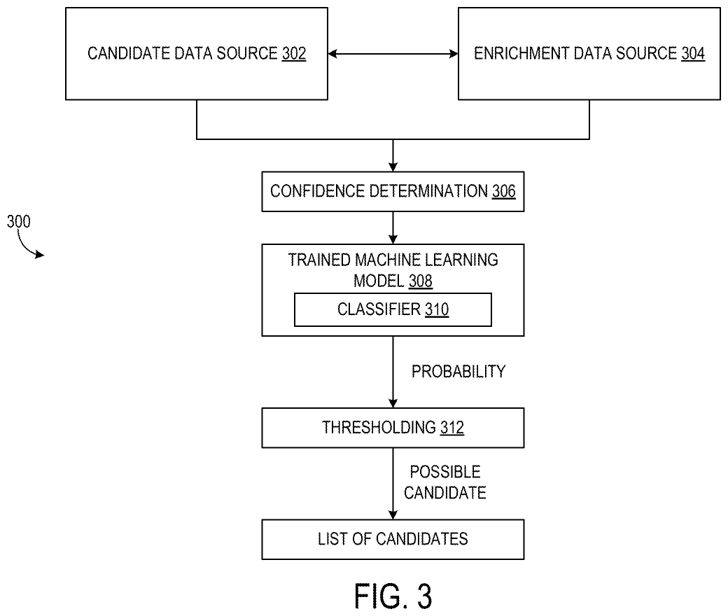

FIG. 3 schematically depicts an example system 300 for generating a list of candidates based upon a probability that each candidate will take an action of interest. In this example, probabilities computed for possible candidates do not include conditional probabilities based upon an identity of a possible contact who may contact the possible candidate. System 300 can be implemented in use environment 200, for example.

System 300 includes a data source 302 configured to provide information regarding the identity of a possible candidate. In various examples, the information regarding the possible candidate identity may include one or more of a first name, last name, email address, phone number, postal address, mobile advertising ID and/or other digital data, and/or any other suitable information regarding the identity of the possible candidate. System 300 further includes an enrichment data source 304 configured to provide enrichment data regarding the possible candidate. The enrichment data may be obtained by providing at least part of the information regarding the possible candidate identity obtained from data source 302 to data source 304. The enrichment data may include any suitable information regarding the possible candidate, including but not limited to demographic information (e.g., ethnicity, gender, age), financial information (e.g., income, credit history), and/or lifestyle preference information (e.g. hobbies, sports, apparel). In some examples, candidate data source 302 and/or enrichment data source 304 may be provided by a common host (e.g., remote data service 204). In other examples, data sources 302 and 304 may be respectively provided by different hosts. As a particular example, candidate data source 302 may be hosted by an organization that utilizes enrichment data source 304 as a third-party service to acquire enrichment data regarding possible candidates amassed by the organization. Enrichment data may be obtained in any suitable manner. In some examples, referring briefly back to FIG. 2, data service 204 may obtain enrichment data, from performing user analytics, from user survey data, and/or from third party data services 213. Third party data services 213 may obtain enrichment data similarly. Examples of user analytics may include capturing instances of users viewing content offered by data service 204 (e.g. video content, audio content, image content, advertising content, etc.), Other examples include capturing instances of users purchasing products, and/or otherwise engaging with technology platforms.

In some examples, enrichment data source 304 may return, along with enrichment data for a possible candidate, a match quality score. The match quality score may indicate the quality of a match between the identity of the possible candidate, as represented by the information regarding their identity obtained from candidate data source 302, and the identity of the candidate as represented by the enrichment data obtained for the candidate from enrichment data source 304. The match quality score may be provided to a confidence determination module 306 configured to determine a confidence regarding the identity of the possible candidate. Module 306 may determine whether the confidence regarding the identity of the possible candidate satisfies a threshold condition. Where the confidence does satisfy the threshold condition, a probability for possible candidate taking an action of interest may be computed as described below. Conversely, where the confidence does not satisfy the threshold condition, probability determination for the possible candidate may be foregone, such that the possible candidate is not added to a list of possible candidates ultimately provided to an end user.

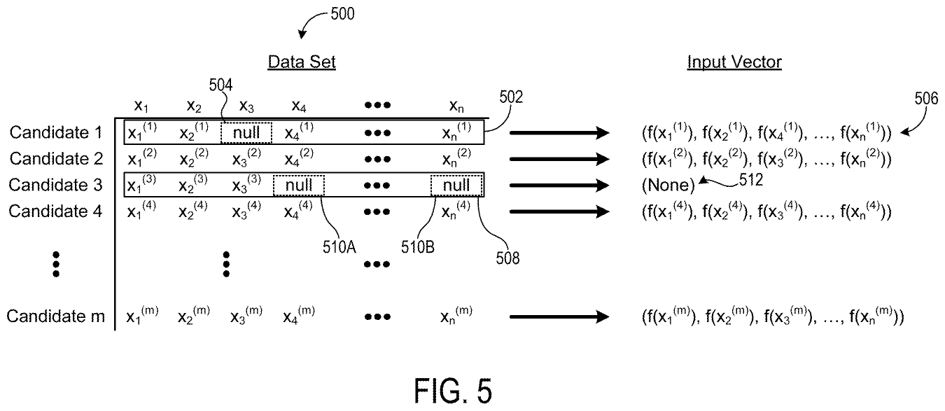

In some examples, the threshold condition may be defined such that the condition is satisfied if the match quality score meets or exceeds a threshold score. The threshold score may be determined, for example, based on an analysis of match quality scores returned by enrichment data source 304, such as an analysis of the distribution of scores (e.g., with regard to an external evaluation metric for accuracy). Alternatively or additionally to defining the threshold condition in terms of the match quality score, the threshold condition may be defined in terms of the enrichment data obtained for the possible candidate. In such examples, the threshold condition may not be satisfied if one or more selected attributes of the enrichment data comprise a null or like value (e.g., empty, not a number (NaN)). Additional detail regarding example enrichment data and an example analysis thereof is described below with reference to FIG. 5.

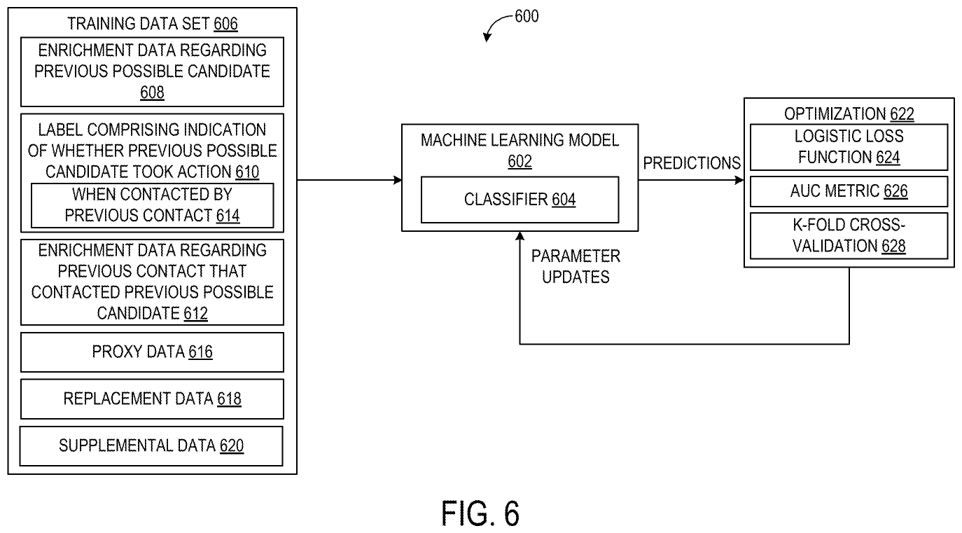

When the confidence regarding the identity of the possible candidate satisfies the threshold condition, a probability that the possible candidate will take an action of interest is determined via a trained machine learning model 308. The probability may be determined by inputting at least part of one or more of the information regarding the identity of the possible candidate obtained from candidate data source 302, and the enrichment data for the possible candidate obtained from enrichment data source 304, into machine learning model 308. As described in more detail below with reference to FIG. 6, in some examples machine learning model 308 may comprise a classifier 310, such as a gradient boosting classifier that includes an ensemble of decision trees, where the model is trained based on data regarding previous possible candidates including labels indicating whether the previous candidates did or did not take the action of interest. In other examples, any other suitable machine learning model may be used.

The probability determined via machine learning model 308 regarding the possible candidate taking the action of interest is provided to a thresholding module 312 configured to compare the probability to a threshold probability. When the probability meets the threshold condition (e.g. meets or exceeds the threshold probability in some examples), the possible candidate is added to a list of candidates each having a probability that meets or exceeds the threshold probability of the candidate taking the action of interest. As shown in the examples depicted in FIGS. 1A-1D and 2, the list of possible candidates may be output to a computing device of a possible contact, for example.

In some examples, the threshold probability may be established based on one or more performance metrics of machine learning model 308, such as one or both of the precision and recall of the model. Alternatively or additionally, the threshold probability may be established based on user preference, which may allow recipients of possible candidate lists to vary a sensitivity with which possible candidates are identified.

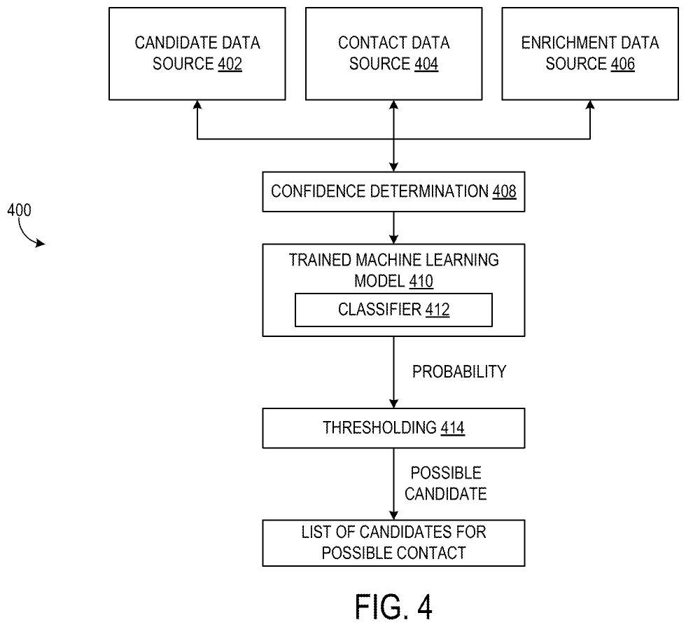

FIG. 4 depicts an example system 400 configured to generate a list of possible candidates each accompanied by a probability that the corresponding possible candidate will take an action of interest when contacted by a possible contact. In this example, probabilities computed for possible candidates include conditional probabilities that account for how the likelihood that the action of interest will be taken may be affected by the identity of a possible contact who contacts the possible candidate.

System 400 includes a candidate data source 402 configured to provide information regarding the identity of a possible candidate, and a contact data source 404 configured to provide information regarding the identity of a possible contact. The information regarding the identity of the possible candidate and possible contact may include one or more of a first name, last name, email address, phone number, postal address, and/or any other suitable information regarding the identity of the possible candidate. System 400 also includes an enrichment data source 406 configured to provide enrichment data regarding the possible candidate and the possible contact. Enrichment data source 406 can represent a single source, or multiple sources. The enrichment data regarding the possible candidate may be obtained by inputting at least part of the information regarding the identity of the possible candidate to enrichment data source 406, and the enrichment data regarding the possible contact may be obtained by inputting at least part of the information regarding the identity of the possible contact to the enrichment data source, for example. The enrichment data may include demographic information, financial information, lifestyle preference information, and/or any other suitable information. While FIG. 4 depicts a common data source—enrichment data source 406—as providing enrichment data regarding both the possible candidate and the possible candidate, in other examples separate data sources may provide enrichment data regarding the possible candidate and enrichment data regarding the possible candidate, respectively.

System 400 includes a confidence determination module 408 configured to determine a confidence regarding the identity of the possible candidate. Module 408 may determine whether the confidence regarding the identity of the possible candidate satisfies a threshold condition. Where the confidence does satisfy the threshold condition, a probability for the possible candidate taking an action of interest may be computed, as described below. Conversely, where the confidence does not satisfy the threshold condition, the possible candidate is not added to a list of possible candidates ultimately provided to an end user. As described above with reference to FIG. 3, confidence determination in some examples may include assessing a match quality score returned by enrichment data source 406 satisfies a threshold condition, where the match quality score indicates the quality of a match between the identity of the possible candidate, as represented by the information regarding their identity obtained from candidate data source 402, and the identity of the candidate as represented by the enrichment data obtained for the candidate from enrichment data source 406. Alternatively or additionally, confidence determination may include assessing whether one or more selected attributes of the enrichment data regarding the possible candidate comprise a null or like value.

Where confidence determination module 408 determines that the confidence does satisfy the threshold condition, a probability for the possible candidate taking an action of interest—conditional upon being contacted by the possible contact—is computed. Conversely, where the confidence does not satisfy the threshold condition the possible candidate is not added to a list of possible candidates, for a possible contact, ultimately provided to an end user. As described above, confidence determination regarding the possible contact may include assessing a match quality score returned by enrichment data source 406 regarding the identity of the possible contact, and/or assessing whether one or more selected attributes of the enrichment data regarding the possible contact comprise a null or like value. Further, while a common threshold condition may be defined for assessing the confidence of both the possible candidate and possible contact, examples are possible in which different threshold conditions are defined for assessing the confidence of the possible candidate and possible contact, respectively.

When the confidence regarding the identity of the possible candidate, and/or the confidence regarding the identity of the possible contact, satisfies the threshold condition, a probability that the possible candidate will take an action of interest when contacted by the possible contact is calculated via a trained machine learning model 410. The probability may be determined by inputting at least part of one or more of the information regarding the identity of the possible candidate obtained from candidate data source 402, the information regarding the identity of the possible contact obtained from contact data source 404, the enrichment data for the possible candidate obtained from enrichment data source 406, and the enrichment data for the possible contact obtained from the enrichment data source, into machine learning model 410. As described below with reference to FIG. 6, in some examples machine learning model 410 may comprise a classifier 412, such as a gradient boosting classifier that includes an ensemble of decision trees, where the model is trained based on data regarding previous possible candidates including labels indicating whether the previous candidates did or did not take the action of interest when contacted by a previous contact. In other examples, any other suitable machine learning model may be used, including but not limited to a support vector machine, random forest classifier, logistic regression classifier, and k-nearest neighbor classifier.

The probability determined via machine learning model 410 regarding the possible candidate taking the action of interest is provided to a thresholding module 414 configured to compare the probability to a threshold probability. When the probability meets or exceeds the threshold probability, the possible candidate is added to a list of possible candidates each having a probability that meets or exceeds the threshold probability. As such, the list of possible candidates may comprise candidates whose probabilities are maximized if contacted by the possible contact, as opposed to other possible contacts. For other possible contacts, respective lists of possible candidates whose probabilities are maximized if contacted by the other possible contact may be formulated and provided to the other possible contact. As shown in the examples depicted in FIGS. 1A-2, a list of possible candidates may be output to a computing device associated with an end user such as the possible contact for which the list was generated. As used herein, a probability being “maximized” may refer to a local or global determined maximum, and as such may or may not refer to an actual maximum.

As described above, in some examples a confidence regarding the identity of a possible candidate may be determined based on the values of one or more selected attributes of enrichment data regarding the possible candidate. Similarly, in some examples a confidence regarding the identity of a possible contact may be determined based on the values of one or more selected attributes of enrichment data regarding the possible contact. FIG. 5 schematically depicts an example data set 500 from which at least a portion of input data may be derived that is input to a machine learning model to obtain a probability of a possible contact taking an action of interest. Data set 500 includes enrichment data for m possible candidates. While data set 500 is depicted in row/column format in this schematic example, a data set comprising identity information and enrichment information may take any suitable form.

FIG. 5 depicts a row 502 of data set 500 that comprises a plurality of attribute or feature values for a first possible candidate. A selected attribute 504 of the plurality of attributes has a value of null, while the other attributes of the plurality of attributes have non-null values. In this example, the threshold condition, against which a confidence of the identity of the first possible candidate is compared, is defined such that the threshold condition is satisfied even if the value of selected attribute 504 is null, as in this example, value X₃ is not used in an input vector 506 for the machine learning function to perform classification. As such, the confidence regarding the identity of the first possible candidate satisfies the threshold condition, leading to the formulation of input vector 506 that may be input to a machine learning model to determine a probability that the first possible candidate takes an action of interest.

FIG. 5 also depicts a row 508 that comprises a plurality of attribute or feature values for a second possible candidate. Two selected attributes 510A and 510B of the plurality of attributes have values of null, while the other attributes of the plurality of attributes have non-null values. Here, row 508 has null value for value Xₙ, which is used in the feature vector for classification. As such, the confidence regarding the identity of the possible candidate of row 508 does not satisfy the threshold condition. In this example, it may be determined based on the attribute(s) having null values that a match of insufficient quality for the possible candidate is obtained, and thus inferences regarding the possible candidate's interest in those categories cannot be obtained. In some examples, a variable that is used in the feature vector can have a null value, and yet the data can still meet the quality threshold, depending upon how the threshold condition is defined.

It will be understood that, in some examples, an input vector input to a machine learning model may be modified relative to an original attribute vector from which the input vector is derived. For example, input vector 506 may comprise attributes other than those included in row 502 of data set 500. Instead, an input vector may comprise attributes that are engineered and/or transformed (e.g., into features, input vectors), resulting in a vector length that may differ from the length of a corresponding original attribute vector. Accordingly, input vectors shown in FIG. 5 are depicted as including attributes that may be functions of original attributes obtained from data set 500.

FIG. 5 illustrates how confidence regarding possible candidate identity may be assessed based at least on enrichment data regarding possible candidates. As described above, confidence regarding possible contact identity may also be assessed based on enrichment data regarding possible contacts. In such examples, a threshold condition may be defined such that, if one or more selected attributes of a data set portion regarding a possible contact have values of null or the like, an input vector is not formulated based on the portion or input to a machine learning model to determine a probability involving the possible contact.

FIG. 6 schematically depicts an example flow diagram 600 illustrating the training of a machine learning model 602. In some examples, model 602 may be trained to output a prediction, for an input possible candidate, regarding whether the possible candidate will eventually take an action of interest. In other examples, model 602 may be trained to output a prediction, for an input possible candidate and input contact, regarding whether the possible candidate will eventually take an action of interest after being contacted by the input contact.

In the depicted example, model 602 includes a classifier 604 configured to output predictions regarding input possible candidates. In some examples, classifier 604 may include an ensemble of n decision trees, where n is an integer. As described below, the number n of decision trees may be selected based on performing cross-validation. As a more specific example, classifier 604 may comprise a gradient boosting classifier comprising an ensemble of n decision trees. In such examples, training model 602 may include using gradient boosting. In other examples, alternatively or in addition to the inclusion of classifier 604, model 602 may include other machine learning models, including but not limited to a forward-feeding neural network (e.g., a multilayer perceptron classifier), support vector machine, random forest classifier, logistic regression classifier, and k-nearest neighbor classifier. Generally, model 602 may comprise a plurality of parameters having values that are determined based on an optimization process described below in which parameter tuning is performed.

Model 602 may be trained to output predictions of a probability that an input possible candidate will take an action of interest, based on a training data set 606. Training data set 606 may include, for each of a plurality of previous possible candidates, enrichment data 608 regarding the previous possible candidate. Further, training data set 606 may include, for each of the plurality of previous possible candidates, a label 610 comprising an indication (e.g., binary indication) of whether the previous possible candidate took an action of interest. Previous possible candidates are candidates for which enrichment data is available, and for which an outcome is known (e.g. whether or not a possible candidate took the action of interest).

For examples in which model 602 is trained to output predictions regarding whether input possible candidates eventually take an action of interest conditional upon being contacted by an input possible contact, training data set 606 includes enrichment data 612 regarding one or more previous possible contacts that each previously contacted one or more previous possible candidates. Further, in such examples, training data set 606 may include, for each of the plurality of previous possible candidates, a label 614 comprising an indication of whether the previous possible candidate took an action of interest after being contacted by a previous possible contact. For a model that outputs a prediction based upon enrichment data for a possible candidate but not for a possible contact, the training data can omit the possible contact information.

The enrichment data included in training data set 606 may comprise a plurality of features, which may be one-hot encoded or encoded in any other suitable format. In some examples, one or more of the plurality of features may be discarded from training data set 606—and thus not used to train model 602—due to multicollinearity. Further, any suitable preprocessing may be performed on training data set 606, including but not limited to scaling and normalization. In some examples, the plurality of previous possible candidates for which training data set 606 includes data may belong to one of two imbalanced classes—for example, a relatively greater portion of the previous possible candidates may have taken the action of interest for which model 602 is trained to predict than the portion that did not take the action of interest. As such, configuring model 602 may include balancing the imbalanced classes. As one example, a scalar may be defined as the ratio of negative to positive observations in training data set 606, where a negative observation is defined as a previous possible candidate who did not take the action of interest, and a positive observation is defined as a previous possible candidate who did take the action of interest.

In some examples, it may be difficult to obtain a desired training data set that comprises data regarding previous possible candidates who did not take the action of interest. This may arise from an organizational tendency not to collect or retain data on previous possible candidates that did not take the action of interest due to their relative lack of organizational value relative to previous possible candidates that did take the action of interest. In such examples, an organization seeking to train model 602 to predict outcomes regarding possible candidates taking an action of interest involving the organization may be unable to sufficiently train the model with data regarding previous possible candidates who did not take the action of interest with respect to the organization. As such, training data set 606 may include proxy training data 616 comprising data regarding previous possible candidates who did not take an action of interest, where the action of interest does not involve an organization to which input candidates belong that model 602 is used to obtain predictions for. For example, model 602 may be configured to output predictions regarding input candidates that are members of a first organization, while being trained to output such predictions based on proxy data 616 regarding previous possible candidates who did not take the action of interest and were or are members of one or more different organizations than the first organization. To sufficiently approximate data for input candidates for which training data is not available, proxy data 616 may be selected from among candidates that belong to a relatively unbiased audience, for example.

In some examples in which proxy data 616 is used to at least partially train model 602, at least a portion of the proxy data may be replaced with replacement data 618 regarding a plurality of previous possible candidates that are members of an organization to which input candidates belong that model 602 is trained to output predictions for. As such, upon obtaining replacement data 618, model 602 may be trained based on at least a portion of the replacement data in lieu of at least a portion of proxy data 616. Proxy data 616 may be replaced by replacement data 618 to any suitable extent at any suitable frequency. Further, training data set 606 may include supplemental data 620 with which model 602 may be at least partially retrained. Supplemental data 620 may supplement or replace at least a portion of training data previously used to train model 602. As such, supplemental data 620 may include data regarding previous possible candidates including labels indicating whether each previous possible candidate took an action of interest. In some examples, supplemental data 620 may include labels indicating whether each previous possible candidate took an action of interest after being contacted by a respective previous contact.

Flow diagram 600 depicts an optimization stage 622 at which one or more parameters of model 602 are updated. In some examples, parameter(s) of model 602 may be updated based on minimizing or otherwise reducing a logistic loss function 624. Loss function 624 may measure a difference between a prediction (e.g., probability rounded to one of two binary outcomes) output by model 602 for whether a previous possible candidate took an action of interest, and a label indicating (e.g., a binary outcome) whether the previous possible candidate took the action of interest. In other examples, model 602 may be configured for multiclass classification. In such a use context, a softmax function may be used in lieu of logistic loss function 624, for example.

Optimization stage 622 may include tuning one or more parameters of model 602 based at least on an evaluation metric, such as an area under a receiver operating characteristic curve metric 626. For example, parameter(s) may be selected based on maximizing metric 626. Further, optimization stage 622 may include tuning one or more parameters of model 602 based on applying k-fold cross-validation 628 to at least a portion of training data set 606. As one example, metric 626 and k-fold cross-validation 628 may be used to select the n number of decision trees of classifier 604 for examples in which the classifier comprises an ensemble of n decision trees.

As described above, probabilities output by model 602 may be compared to a threshold probability in service of determining which possible candidates to include in a list of candidates ultimately output to an end user. In some examples, the threshold probability may be determined based at least on one or more performance metrics of model 602, including but not limited to the precision and/or recall of the model.

As also noted above, model 602 may be trained to output probabilities regarding possible candidates conditional upon being contacted by a possible contact. Where the enrichment data for two or more possible candidates share a substantial number of attribute values, model 602 may learn to identify which attributed associated with a possible contact are associated with outcomes in which a possible candidate does and does not take an action of interest. Further, model 602 may output a possible candidate in a list of possible candidates for a possible contact, where the possible candidate would not be included in a list of possible candidates for which probabilities are determined that are not conditional upon being contacted by a possible contact. In other words, a possible candidate may have a probability, conditional upon a possible contact, that meets a threshold probability and is thus included in a list of possible candidates output to an end user, whereas the same possible candidate may have a probability, not conditional upon a possible contact, that does not meet the threshold probability and is thus omitted from a list of possible candidates ultimately output to an end user. As such, training model 602 to output probabilities for possible candidates conditional upon possible contacts may produce lists of possible candidates with relatively less false negatives as compared to training the model to output probabilities for possible candidates not conditional upon possible contacts.

Further, examples are possible in which model 602 is configured to output probabilities for possible candidates conditional upon a selected possible contact, such as a user of application 102 or other requestor of a list of possible candidates. In such examples, probabilities may be personalized to the selected possible contact. In other examples, model 602 may be configured to output probabilities for one or more pairs of possible candidates and possible contacts, such that a probability is determined for each possible candidate-possible contact pair. In such examples, the probability determined for a given possible candidate-possible contact pair may be conditional upon the possible candidate being contacted by the possible contact. Model 602 may be configured in this manner by an organization to identify the possible contact, for one or more possible candidates, for which probability is maximized (e.g., relative to other possible contacts).

In some examples, a candidate in a list of candidates output by model 602 may be identified (e.g., by data service 204) to a first end user and not to other end users (e.g., by limiting transmission of the list to computing device(s) associated with the first end user and not the other users). A higher probability may be determined for the possible candidate taking an action of interest when contacted by the first end user as compared to probabilities determined for the possible candidate taking the action of interest when contacted by the other users. Without limiting the assignment of the candidate to the first end user, another end user may attempt to engage the candidate and, observe the candidate did not take the action of interest, potentially leading to recording a false positive. As such, this limitation may reduce the number of false positives output by model 602. Further, a list of candidates may be output to a device associated with a contact in a list of possible contacts, but not to a device associated with another contact in the list of possible contacts.

Other types of data may be used to train model 602 and obtain predictions regarding possible candidates than the types of data that may potentially be included in training data set 606. For example, behavioral data, such as data regarding events involving a possible candidate, may be used to inform model 602. Examples of behavioral data include data regarding in-person events (e.g., meetings) involving the possible candidate, information regarding an event occurring between the last contact to contact the possible candidate and the possible candidate, and/or data regarding an individual who sent a possible candidate a gift (e.g., digital content, a physical sample, etc.). In such examples, information input to model 602, such as information regarding the identity of a contact who contacted the possible candidate and/or enrichment data regarding the contact, may be replaced with information regarding the individual (e.g., information regarding the identity of the individual, enrichment data regarding the individual) who sent the possible candidate the gift. Yet other types of data may be used to inform model 602, such as data regarding possible candidates and geographic regions (e.g., counties, zip codes) and/or socioeconomic factors associated with those possible candidates. In such examples, model 602 may be trained based at least on such data to output, for an input candidate (as represented by an input set of attribute values/filters, such as illustrated by the vectors of FIG. 5), and a geographic region, other geographic regions in which possible candidates are likely to take an action of interest. In these examples, data that is not personalized to individual candidates may be used to reveal socioeconomic trends in geographic areas, where such trends may provide predictive information for configuring a machine learning model to find other geographic areas likely to exhibit such trends.

As described above, the machine learning models described herein may be trained to predict probabilities that input candidates will take any suitable actions of interest. Such actions of interest may include but are not limited to an input candidate purchasing a product, subscribing to a service, and becoming a member of an organization or otherwise being recruited to an organization. Examples of organizations for which machine learning models may be trained to predict outcomes of interest include for-profit and non-profit organizations. For example, a machine learning model may be trained for the purpose of matching potential donors (e.g., philanthropists) to non-profit organizations. As another example, a machine learning model may be trained to predict outcomes of interest for academic institutions attempting to recruit potential students. Further, a machine learning model trained to predict outcomes of interest may be used to learn characteristics of ideal possible candidates, where such characteristics may inform future candidate selection and operations of an organization.

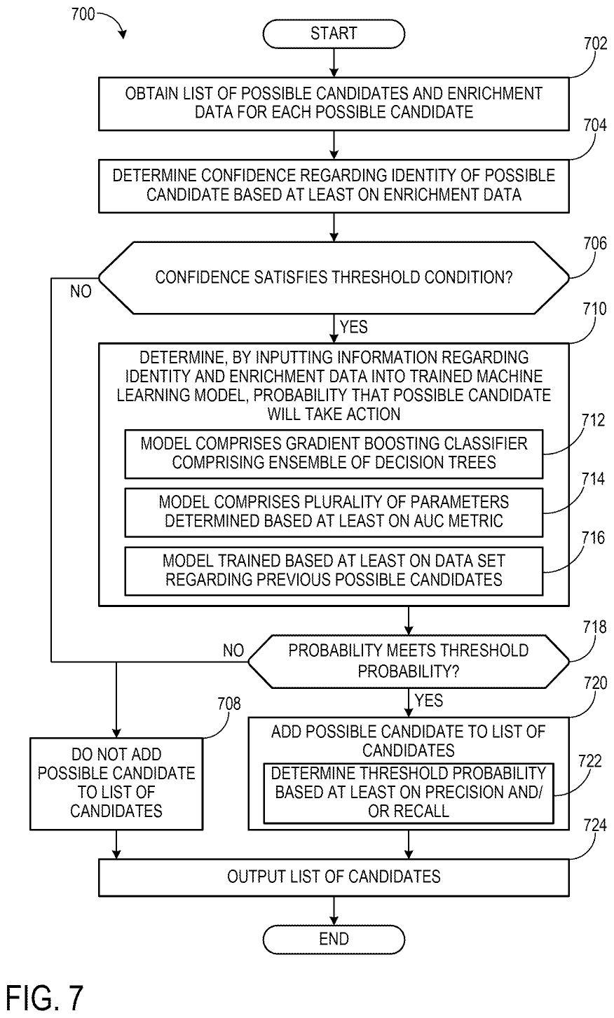

FIG. 7 depicts a flowchart illustrating a method 700 of generating and outputting a list of possible candidates each with a corresponding probability that the possible candidate will take an action of interest. Method 700 may be implemented at least in part at system 200, for example.

At 702, method 700 includes obtaining a list of possible candidates and enrichment data for each possible candidate on the list of possible candidates. The enrichment data may comprise one or more of demographic information, financial information, or lifestyle preferences information. The possible candidates may each comprise one of an individual or an organization. At 704, method 700 includes, for each possible candidate on the list of possible candidates, determining a confidence regarding an identity of the possible candidate based at least on the enrichment data. At 706, method 700 includes determining whether the confidence regarding the identity of the possible candidate satisfies a threshold condition. The threshold condition may be defined based on a match quality score regarding the identity of the possible candidate and/or based on the values of one or more selected attributes of the enrichment data.

When it is determined that the confidence regarding the identity of the possible candidate does not satisfy the threshold condition (NO), method 700 proceeds to 708 at which the possible candidate is not added to a list of candidates. When it is determined that the confidence regarding the identity of the possible candidate does satisfy the threshold condition (YES), method 700 proceeds to 710. At 710, method 700 includes determining, by inputting information regarding the identity of the possible candidate and the enrichment data for the possible candidate into a trained machine learning model, a probability that the possible candidate will take the action of interest. In some examples, the model may comprise a gradient boosting classifier 712 comprising an ensemble of decision trees. In other examples, any other suitable type of model may be used. The model may comprise a plurality of parameters 714 determined based at least on an area under the receiver operating characteristic curve metric. The model may be trained based at least on a data set 716 regarding a plurality of previous possible candidates, the data set including, for each previous possible candidate of the plurality of previous possible candidates, enrichment data regarding the previous possible candidate, and a label comprising an indication of whether the previous possible candidate took the action of interest.

At 718, method 700 includes determining whether the probability meets a threshold probability. When the probability does not meet the threshold probability (NO), method 700 proceeds to 708 where the possible candidate is not added to the list of candidates. When the probability does meet the threshold probability (YES), method 700 proceeds to 720 where the possible candidate is added to the list of candidates. Method 700 may include determining 722 the threshold probability based at least on the precision and/or recall of the machine learning model. At 724, method 700 includes outputting the list of candidates.

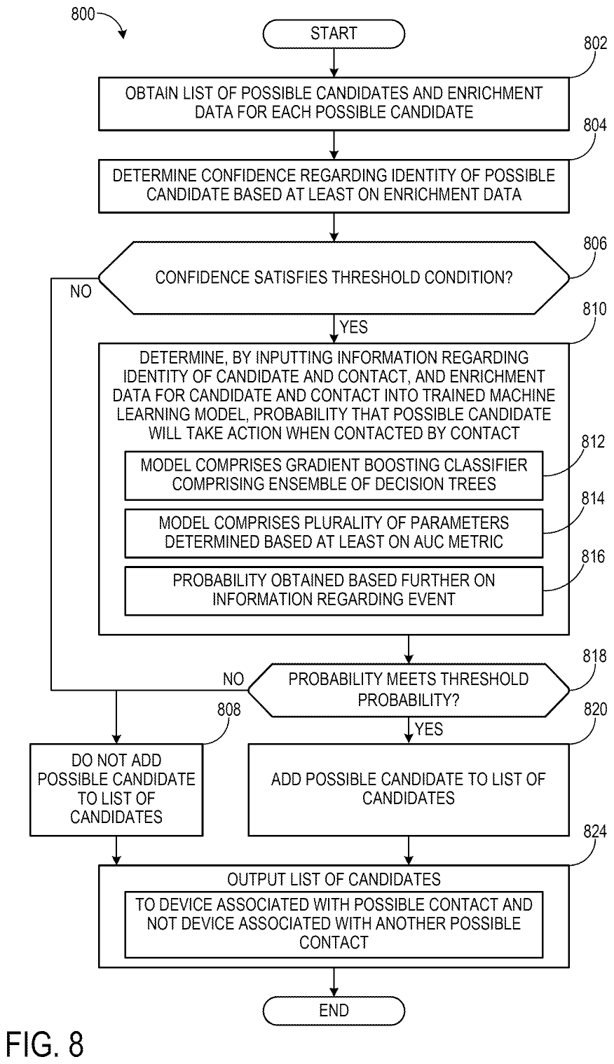

FIG. 8 depicts a flowchart illustrating a method 800 of outputting a list of possible candidates each with a corresponding probability that the possible candidate will take an action of interest when contacted by a possible contact. Method 800 may be implemented at least in part at system 200, for example.

At 802, method 800 includes obtaining a list of possible candidates, and for each possible candidate on the list of possible candidates, obtaining enrichment data for the possible candidate. Enrichment data for one or more possible contacts may further be obtained. At 804, method 800 includes determining a confidence regarding an identity of the possible candidate based at least on the enrichment data. At 806, method 800 includes determining whether the confidence regarding the identity of the possible candidate satisfies a threshold condition. When the confidence regarding the identity of the possible candidate does not satisfy the threshold condition (NO), method 800 proceeds to 808 where the possible candidate is not added to a list of candidates. When the confidence regarding the identity of the possible candidate does satisfy the threshold condition (YES), method 800 proceeds to 810. In some examples, a confidence regarding the identity of a possible contact may also be determined and compared against the threshold condition. In such examples, if either the confidence regarding the possible candidate or the confidence regarding the possible contact satisfies the threshold condition, method 800 may proceed to 810. In other examples, if either or both the confidence regarding the possible candidate and the confidence regarding the possible contact does not satisfy the threshold condition, method 800 may proceed to 808. In yet other examples, different threshold conditions may be defined for and compared against the possible candidate and possible contact, respectively. Further, the determination at 806 may be on a per-possible-contact basis, such that whether method 800 proceeds to 808 or 810 may differ for different possible contacts when evaluated against a common possible candidate.

At 810, method 800 includes, for a plurality of possible contact/possible candidate pairs, inputting information regarding the identity of the possible candidate, the enrichment data for the possible candidate, an identity of the possible contact, and enrichment data for the possible contact, into a trained machine learning model to obtain a probability that the possible candidate will take an action of interest when contacted by the possible contact. In some examples, the model may comprise a gradient boosting classifier 712 comprising an ensemble of decision trees. In other examples, any other suitable type of model may be used. The model may comprise a plurality of parameters 714 determined based at least on an area under the receiver operating characteristic curve metric. The probability may be obtained based further on information 816 regarding an event occurring between a last contact to contact the possible candidate and the possible candidate.

At 818, method 800 includes determining whether the probability meets a threshold probability. When the probability does not meet the threshold probability (NO), method 800 proceeds to 808 where the possible candidate is not added to the list of candidates. When the probability does meet the threshold probability (YES), method 800 proceeds to 820 where the possible candidate is added to the list of candidates for the possible contact for whom the probability is maximized. At 822, method 800 includes outputting the list of candidates for the possible contact. Method 800 may include outputting the list of candidates to a device associated with the possible contact and not to a device associated with another possible contact in the list of possible contacts. In some embodiments, the methods and processes described herein may be tied to a computing system of one or more computing devices. In particular, such methods and processes may be implemented as a computer-application program or service, an application-programming interface (API), a library, and/or other computer-program product.

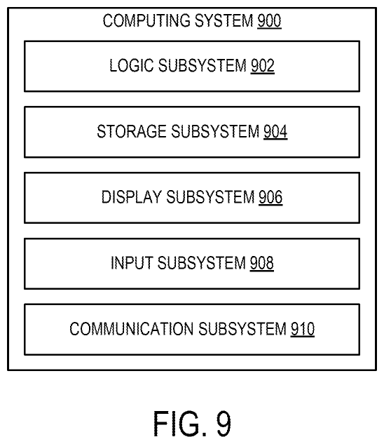

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices including but not limited to computing devices 100 and/or 202, data services 204 and 213, databases 209 and 211, and any other device described herein.

Computing system 900 includes a logic subsystem 902 and a storage subsystem 904. Computing system 900 may optionally include a display subsystem 906, input subsystem 908, communication subsystem 910, and/or other components not shown in FIG. 9.

Logic subsystem 902 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors configured to execute software instructions. Additionally or alternatively, the logic subsystem may include one or more hardware or firmware logic subsystems configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 904 includes one or more physical devices configured to hold instructions executable by the logic subsystem to implement the methods and processes described herein. When such methods and processes are implemented, the state of storage subsystem 904 may be transformed—e.g., to hold different data.

Storage subsystem 904 may include removable and/or built-in devices. Storage subsystem 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 904 may include volatile, nonvolatile, dynamic, static, read/write, read-only, random-access, sequential-access, location-addressable, file-addressable, and/or content-addressable devices.

It will be appreciated that storage subsystem 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 902 and storage subsystem 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and may be used to describe an aspect of computing system 900 implemented to perform a particular function. In some cases, a module or program may be instantiated via logic subsystem 902 executing instructions held by storage subsystem 904. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms “module,” and “program,” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 906 may be used to present a visual representation of data held by storage subsystem 904. This visual representation may take the form of a GUI. As the herein described methods and processes change the data held by the storage subsystem, and thus transform the state of the storage subsystem, the state of display subsystem 906 may likewise be transformed to visually represent changes in the underlying data. Display subsystem 906 may include one or more display devices utilizing virtually any type of technology. Such display devices may be combined with logic subsystem 902 and/or storage subsystem 904 in a shared enclosure, or such display devices may be peripheral display devices.

When included, input subsystem 908 may comprise or interface with one or more user-input devices such as a keyboard, mouse, or touch screen. In some embodiments, the input subsystem may comprise or interface with selected NUI componentry. Such componentry may be integrated or peripheral, and the transduction and/or processing of input actions may be handled on- or off-board. Example NUI componentry may include a microphone for speech and/or voice recognition and input; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a logic subsystem; and
a storage subsystem comprising instructions executable by the logic subsystem to
obtain a list of possible candidates and enrichment data for each possible candidate on the list of possible candidates;
for each possible candidate on the list of possible candidates,
determine a confidence regarding an identity of the possible candidate based at least on the enrichment data,
when the confidence regarding the identity of the possible candidate satisfies a threshold condition, determine, by inputting information regarding the identity of the possible candidate and the enrichment data for the possible candidate into a trained machine learning model, a probability that the possible candidate will take an action of interest, and
when the probability meets a threshold probability, then add the possible candidate to a list of candidates; and
output the list of candidates.

2. The computing system of claim 1, wherein the enrichment data comprises one or more of demographic information, financial information, or lifestyle preferences information.

3. The computing system of claim 1, wherein the machine learning model comprises a gradient boosting classifier comprising an ensemble of decision trees.

4. The computing system of claim 1, wherein the machine learning model comprises a plurality of parameters having values determined based at least on an area under a receiver operating characteristic curve metric.

5. The computing system of claim 1, wherein the machine learning model is trained based at least on a data set regarding a plurality of previous possible candidates, the data set including, for each previous possible candidate of the plurality of previous possible candidates, enrichment data regarding the previous possible candidate, and a label comprising an indication of whether the previous possible candidate took the action of interest.

6. The computing system of claim 5, wherein the plurality of previous possible candidates are members of a first organization, and wherein the possible candidate is a member of a second organization different from the first organization.

7. The computing system of claim 1, further comprising instructions executable to determine the threshold probability based at least on one or both of a precision or a recall of the machine learning model.

8. The computing system of claim 1, wherein the possible candidate comprises one of an individual or an organization.

9. A method, comprising
obtaining a list of possible candidates;
for each possible candidate on the list of possible candidates,
obtaining enrichment data for the possible candidate,
determining a confidence regarding an identity of the possible candidate based at least on the enrichment data,
when the confidence regarding the identity of the possible candidate satisfies a threshold condition,
for a plurality of possible contact/possible candidate pairs,
inputting information regarding the identity of the possible candidate, the enrichment data for the possible candidate, an identity of the possible contact, and enrichment data for the possible contact, into a trained machine learning model to obtain a probability that the possible candidate will take an action of interest when contacted by the possible contact, and
when the probability meets a threshold probability, then adding the possible candidate to a list of candidates for the possible contact for whom the probability is maximized; and
outputting the list of candidates for the possible contact.

10. The method of claim 9, wherein the machine learning model comprises a gradient boosting classifier comprising an ensemble of decision trees.

11. The method of claim 9, wherein the machine learning model comprises a plurality of parameters having values determined based at least on an area under a receiver operating characteristic curve metric.

12. The method of claim 9, further comprising outputting the list of candidates to a device associated with the possible contact and not to a device associated with another possible contact in the list of possible contacts.

13. The method of claim 9, wherein the probability is obtained based further on information regarding an event occurring between a last contact to contact the possible candidate and the possible candidate.

14. A method, comprising
obtaining a training data set regarding a plurality of previous possible candidates and a plurality of previous contacts for the previous possible candidates, the data set including, for each previous possible candidate of the plurality of previous possible candidates, enrichment data regarding the previous possible candidate, enrichment data regarding a previous contact that contacted the previous possible candidate, and a label comprising a binary indication of whether the previous possible candidate eventually took an action of interest when contacted by the previous contact;
training a machine learning model comprising a classifier based at least on a portion of the data set to train the machine learning model to output a prediction, for an input possible candidate and input contact, regarding whether the input possible candidate eventually will take the action of interest;
tuning one or more parameters of the machine learning model based at least on a portion of the data set and an evaluation metric; and
outputting the machine learning model.

15. The method of claim 14, wherein training the machine learning model comprises using gradient boosting.

16. The method of claim 14, wherein each previous possible candidate of the plurality of previous possible candidates belongs to one of two imbalanced classes, further comprising balancing the imbalanced classes.

17. The method of claim 14, wherein tuning the one or more parameters comprises applying k-fold cross validation to at least the portion of the data set.

18. The method of claim 14, wherein the evaluation metric comprises an area under a receiver operating characteristic curve metric.

19. The method of claim 18, wherein the input contact is a member of an organization, further comprising collecting a replacement data set regarding a plurality of previous possible candidates that are members of the organization, and replacing at least a portion of the data set with the replacement data.

20. The method of claim 14, wherein training the machine learning model comprises using a logistic loss function.
